(19) United States
(12) Patent Application Publication
(10) Pub. No.: US 2010/0290155 A1
(43) Pub. Date: Nov. 18, 2010

(54) METHOD OF MANUFACTURING PERPENDICULAR MAGNETIC RECORDING MEDIUM AND MAGNETIC RECORDING AND REPRODUCING APPARATUS

(75) Inventors: Masato FUKUSHIMA, Ichihara-shi (JP); Gohel KUROKAWA, Ichihara-shi (JP); Yuzo SASAKI, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku ,Tokyo (JP)

(21) Appl. No.: 12/741,175

(22) PCT Filed: Oct. 31, 2008
(86) PCT No.: PCT/JP2008/069887

§ 371 Date: Jun. 17, 2010

(30) Foreign Application Priority Data
Nov. 7, 2007 (JP) 2007-289640
Nov. 8, 2007 (JP) 2007-290914
Nov. 8, 2007 (JP) 2007-290915

(51) Int. Cl. G11B 5/127; G11B 5/74; G11B 5/84

(52) U.S. Cl. 360/110; 360/131; 427/533; G9B/5.04; G9B/5.289

(57) ABSTRACT

A method of manufacturing a perpendicular magnetic recording medium is provided which is capable of improving fineness of a particle diameter and vertical orientation of a perpendicular magnetic recording layer, improving corrosion resistance of the magnetic recording medium, and recording and reproducing high-density information. Provided is the method of manufacturing a perpendicular magnetic recording medium (10) of the invention having at least a soft magnetic layer (2), an underlayer (4), an intermediate layer (5), and a perpendicular magnetic recording layer (6) which has a granular magnetic layer including at least an oxide, on a nonmagnetic substrate (1), the method including at least one of: a process of irradiating a surface of the soft magnetic layer with inert gas ions, after forming the soft magnetic layer; a process of irradiating a surface of the intermediate layer with inert gas ions, forming the intermediate layer; and a process of irradiating a surface of the granular magnetic layer with inert gas ions, after forming the granular magnetic layer that constitutes the perpendicular magnetic recording layer.

### TECHNICAL FIELD

The present invention relates to a method of manufacturing a perpendicular magnetic recording medium and a magnetic recording and reproducing apparatus in which the perpendicular magnetic recording medium is used. Priority is claimed on Japanese Patent Publication No, 2007-289640 filed on Nov. 7, 2007, Japanese Patent Publication No. 2007-290914 filed on Nov. 8, 2007, and Japanese Patent Publication No. 2007-290915 filed on Nov. 8, 2007, the content of which is incorporated herein by reference.

### BACKGROUND ART

In recent years, the applications of magnetic recording apparatuses such as magnetic, disk devices, flexible disk devices, and magnetic tape devices have remarkably increased, and, as for the magnetic recording mediums used therein, advances in recording density have been achieved. In particular, since the MR head and PRML technique were introduced, the rise in the surface recording density has increased considerably. Recently, the GMR head and Tu MR head were introduced, and the rise has continued to increase at a pace of 100% per year.

In this way, there will be demand for even higher recording density to be achieved in the magnetic recording medium from now on, and for this reason, there is a demand for achieving the high coercivity and the high signal-to-noise ratio (SNR) of the magnetic recording layer, as well as the high resolution. In the longitudinal magnetic recording method which has been hitherto widely used, while the line recording density increases, a self-demagnetization action becomes predominant among adjacent recording magnetic domains in a transition region of magnetization so as to weaken magnetization. Therefore, in order to avoid this action, it is necessary to increase the shape magnetic anisotropy by making the magnetic recording layer thin.

On the other hand, when the film thickness of the magnetic recording layer is made thin, a magnitude of an energy barrier for securing the magnetic domain and a magnitude of heat energy are formed close to the same level, so that it cannot be ignored that the amount of recorded magnetization is alleviated by the influence of the temperature (thermal fluctuation), and this is called the limitation of the line recording density.

In these circumstances, as a technique for improving the line recording density in the longitudinal magnetic recording method, recently, an AFC (Anti Ferro magnetic Coupling) medium has recently been proposed, and many attempts have been made for avoiding the problem of the heat magnetic alleviation which is an issue with the longitudinal magnetic recording.

In addition, there is the perpendicular magnetic recording which has attracted attention as an effective technique for realizing further improved surface recording density in the future. While a medium is subjected to magnetization in an in-plane direction in the longitudinal magnetic recording method according to the related art, in the perpendicular magnetic recording method, the medium is subjected to magnetization in a direction perpendicular to the surface of the medium. As a result, it is possible to avoid the self-demagnetization action which obstructs high line recording density in the longitudinal magnetic recording method, so that it is suitable for higher density recording. In addition, since a constant film thickness of the magnetic layer can be secured, the influence of the heat magnetic relaxation which has been an issue with, the longitudinal magnetic recording may be considered as being comparatively low.

The perpendicular magnetic recording medium is generally manufactured by forming a film on a nonmagnetic substrate in an order of an underlayer, an intermediate layer, a magnetic recording layer, and a protective layer. In addition, a lubricant layer is coated on the surface after the protective layer is formed in many cases. In addition, in many cases, a magnetic film called a soft magnetic layer is provided under an underlayer. The intermediate layer is manufactured for the purpose of increasing the characteristics of the magnetic recording layer. In addition, the underlayer adjusts the crystalline orientation of the intermediate layer and the magnetic recording layer, and functions to control the shape of the magnetic crystal.

In order to manufacture the perpendicular magnetic recording medium with good characteristics, a crystalline structure of the magnetic recording layer is important. That is, in the perpendicular magnetic recording medium, the crystalline structure of the magnetic recording layer is a hexagonal closest packing structure (hcp structure) in many cases, and it is important that the (002) crystal plane be parallel to the substrate surface. In other words, it is important that the [002] axis of the crystalline c axis is aligned not to be separated from a vertical direction as close as it can be.

In addition, as shown in Non-Patent Citation 1, S. H. Liou et al has proposed a so-called granular magnetic layer in which the magnetic crystal is separated in the nonmagnetic phase magnetic crystal. In the granular magnetic layer, the magnetic interaction between magnetic particles is weak, and since the magnetic crystalline particles can be formed in fineness, magnetic layer with low noise can be achieved. Further, Patent Citation 1 describes that the granular magnetic layer surface is subjected to reduction treatment by hydrogen plasma since corrosion caused by the granular magnetic layer is prevented.

Further, in the past, in an intermediate layer of the perpendicular magnetic recording medium, Ru has been used which becomes the hexagonal closest packing structure (hcp structure) similar to that of the magnetic recording layer in order to obtain crystal of the magnetic recording layer in which the oscillation is small.

Patent Citation 2 discloses that since the Ru crystal of the magnetic recording layer on the (002) crystal plane grows epitaxially, the magnetic recording medium with good crystalline orientation is obtained.

In addition, Patent Citation 3 discloses that the intermediate layer using Ru is necessary to generally have a film thickness of 10 nm in order to separate Co alloy crystals from each other of the magnetic recording layer.

[Patent Citation 1] JP-A-2006-127619

[Patent Citation 2] JP-A-2001-6158

[Patent Citation 3] JP-A-2005-190517

[Non-Patent Citation 1] S. H. Liou and C. L. Chien, Appl. Phys. Lett. 52(6), 8 Feb. 1988

### DISCLOSURE OF INVENTION

As described above, by employing the granular magnetic layer, it is possible to record and reproduce higher-density information. However, since many elements which easily occur migration of Co atoms are included in a soft magnetic layer constituting the perpendicular magnetic recording medium, there is a problem in that the atoms are diffused in the surface of the perpendicular magnetic recording medium under a high-temperature and high-humidity environment. Here, as described in Patent Citation 1, a method is considered in which the surface of the granular magnetic layer is subjected to a reduction treatment by hydrogen plasma and the migration of Co atoms are also prevented. However, the hydrogen atoms used in the method are diffused inside the magnetic layer, so that there are some concerns that the magnetic characteristics are changed. In addition, it is difficult to control the hydrogen plasma, and the inside of the granular magnetic layer is also subjected to the reduction treatment in some cases.

In addition, when the intermediate layer is formed to be a great film thickness, a radius of a crystal particle of Co alloy of the magnetic recording layer becomes larger, so that the noise is increased. Therefore, there is a problem in that recording and reproducing characteristics of the magnetic recording layer axe deteriorated. Therefore, in order to improve the recording and reproducing characteristics of the magnetic recording layer, as the intermediate layer, the application of other elements or Ru alloy with the hexagonal closest packing structure (hcp structure) such as Ti, Hf, or Zr is proposed. However, it is insufficient for obtaining the perpendicular magnetic recording medium excellent in the recording and reproducing characteristics by making fineness and vertical orientation of a radius of the crystal particles of the magnetic recording layer to be compatible with each other, so that it is desirable that the perpendicular magnetic recording medium which is solved in the problem can be easily manufactured.

Under the circumstances described above, the object of the invention is to provide a method of manufacturing a perpendicular magnetic recording medium and a perpendicular magnetic recording medium, and a magnetic recording and reproducing apparatus, which improve the corrosion resistance of a magnetic recording medium, allow recording and reproducing information in high-density, and are excellent in magnetic recording characteristics.

In order to achieve the above-mentioned object, the invention is disclosed as follows.

(1) A method of manufacturing a perpendicular magnetic recording medium having at least a soft magnetic layer, an underlayer, an intermediate layer, and a perpendicular magnetic recording layer which has a granular magnetic layer including at least an oxide, on a nonmagnetic substrate, the method at least including a process of forming a magnetic layer, an irradiation process with inert gas ions and a process of forming a protective layer, wherein the irradiation process with inert gas ions includes at least one of: a process of irradiating a surface of the soft magnetic layer with inert gas ions, after forming the soft magnetic layer; a process of irradiating a surface of the intermediate layer with inert gas ions, forming the intermediate layer; and a process of irradiating a surface of the granular magnetic layer with inert gas ions, after forming the granular magnetic layer that constitutes the perpendicular magnetic recording layer.

(2) The method of manufacturing the perpendicular magnetic recording medium according to the above-mentioned (1), wherein the inert gases are one or more selected from a group consisting of Ar, He, Xe and Kr.

(3) The method of manufacturing the perpendicular magnetic recording medium according to the above-mentioned (1) or (2), wherein inert gas ions are irradiated by a method selected from a group consisting of an ion gun, inductively-coupled plasma (ICP), and reactive ion plasma (RIE).

(4) A perpendicular magnetic recording medium manufactured by the manufacture method according to any one of the above-mentioned (1) to (3).

(5) A magnetic recording and reproducing apparatus including a perpendicular magnetic recording medium, and a magnetic head that records and reproduces information in the perpendicular magnetic recording medium, wherein the perpendicular magnetic recording medium is a perpendicular magnetic recording medium manufactured by a manufacture method according to any one of the above-mentioned (1) to (3).

According to the invention, it is possible to provide a perpendicular magnetic recording medium that improves corrosion resistance of a magnetic recording medium and has excellent magnetic recording characteristics, or a perpendicular magnetic recording medium and a method of manufacturing a perpendicular magnetic recording medium capable of recording and reproducing high-density information, and a magnetic recording and reproducing apparatus.

### BRIEF DESCRIPTION OF THE DRAWINGS

FIG. 1 is a cross-sectional schematic view of a perpendicular magnetic recording medium showing an embodiment of the invention.

FIG. 2 is a perspective view of a magnetic recording and reproducing apparatus showing the embodiment of the invention.

FIG. 3 is a diagram illustrating an evaluation result of electromagnetic conversion characteristics showing examples 13 to 15 of the invention.

FIG. 4 is a diagram illustrating an evaluation result of environment resistance showing examples 13 to 15 of the invention.

### EXPLANATION OF REFERENCES IN THE FIGURES

1 NONMAGNETIC SUBSTRATE
2 SOFT MAGNETIC LAYER
3 ORIENTATION CONTROL LAYER
4 UNDERLAYER
5 INTERMEDIATE LAYER
6 PERPENDICULAR MAGNETIC RECORDING LAYER
7 PROTECTIVE LAYER
8 LUBRICANT LAYER
10 PERPENDICULAR MAGNETIC RECORDING MEDIUM
100 MAGNETIC RECORDING AND REPRODUCING APPARATUS
101 MEDIUM DRIVING PORTION
102 MAGNETIC HEAD
103 HEAD DRIVING PORTION
104 RECORDING AND REPRODUCING SIGNAL SYSTEM

### BEST MODE FOR CARRYING OUT THE INVENTION

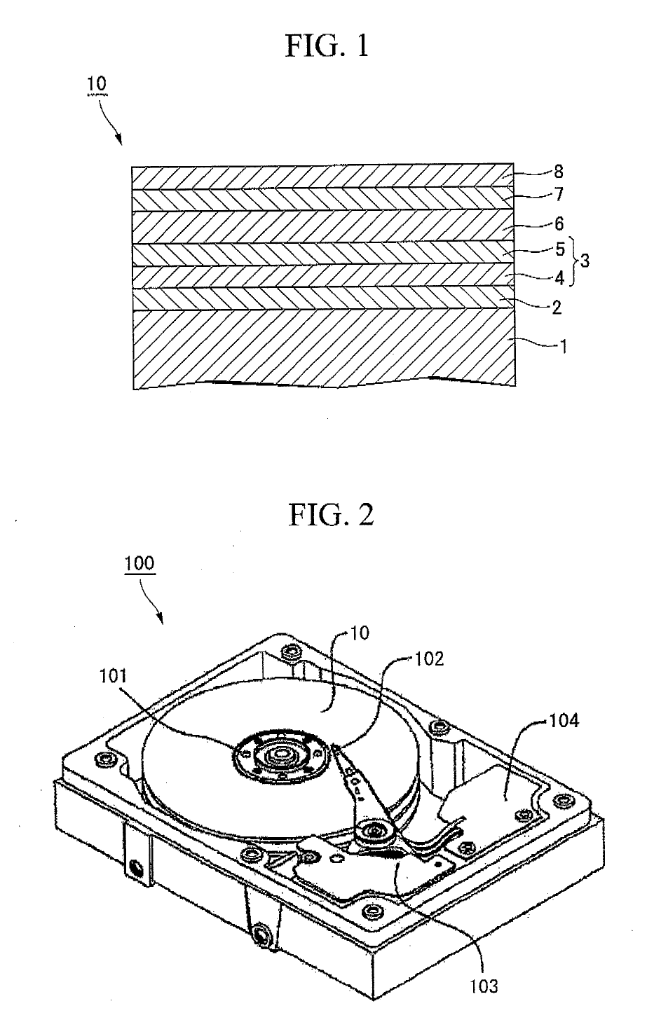

First, a perpendicular magnetic recording medium which is an example of an embodiment of the invention will be described in detail with reference to the drawings. FIG. 1 is a cross-sectional schematic view of the perpendicular magnetic recording medium of the embodiment.

As shown in FIG. 1, a perpendicular magnetic recording medium 10 of the embodiment is schematically formed with at least a soft magnetic layer (soft magnetic underlayer) 2, an orientation control layer 3 composed of an underlayer 4 and an intermediate layer 5, a perpendicular magnetic recording layer 6, a protective layer 7, and an lubricant layer 8 on a nonmagnetic substrate 1. Meanwhile, FIG. 1 is for the purpose of describing the configuration of the perpendicular magnetic recording medium 10 of the embodiment, and there may be cases where sizes or thicknesses or dimensions and the like of each part shown in the drawing are different from the dimensions relationship of the actual perpendicular magnetic recording medium 10. Hereinafter, first, each layer of the perpendicular magnetic recording medium 10 will be described in detail.

Nonmagnetic Substrate

The nonmagnetic substrate 1 is not particularly limited, but can use an arbitrary substrate such as an Al alloy substrate of, for example, an Al—Mg alloy and the like using Al as a major element, or a substrate composed of typical soda glass, aluminosilicate-based glass, a kind of amorphous glass, silicon, titanium, ceramics, sapphire, quartz, and various types of resins, so long as it is a nonmagnetic substrate. More preferably, it is a glass-made substrate such as an Al alloy substrate or crystallized glass, amorphous glass and the like. In addition, when the glass-made substrate is used as the nonmagnetic substrate 1, a mirror polish substrate or a low Ra substrate of which surface roughness (Ra) is less than 1 (Å) and the like are more preferable. Meanwhile, so long as it has a mild degree, texture may be inserted into it.

Soft Magnetic Layer

A soft magnetic layer (soft magnetic underlayer) 2 is a soft magnetic film composed of materials having so-called soft magnetic characteristics such as an FeCo-based alloy, a CoZrNb-based alloy, and a CoTaZr-based alloy, and acts as a function of guiding a recording magnetic field from a head when a signal is recorded in the medium, and efficiently applying a perpendicular component of the recording magnetic field to the perpendicular magnetic recording layer 6. In addition, it is particularly preferable that the soft magnetic layer 2 is an amorphous (noncrystalline) structure. The soft magnetic layer 2 is made an amorphous structure, whereby the surface roughness (Ra) thereof is prevented from becoming large, the amount of surfacing of the head can be reduced, and higher recording density is made possible. Further, the soft magnetic layer 2 can be applied as not only a single layer, but also a layer in which antiferromagnetic coupling (AFC) of soft magnetic layers is performed by interposing an extremely thin nonmagnetic thin film of Ru and the like between two layers. Meanwhile, the total film thickness of the soft magnetic layer 2 is preferably set to a degree of 20 (nm) to 120 (nm), and can be appropriately determined by balances of recording and reproducing characteristics and overwriting (OW) characteristics.

Orientation Control Layer

The orientation control layer 3 is provided over the soft magnetic layer 2, and controls orientation of a film immediately above the orientation control layer 3. In addition, the orientation control layer 3 is composed of a plurality of layers, and the orientation control layer 3 of the embodiment is configured so that the underlayer 4 and the intermediate layer 5 are stacked from the nonmagnetic substrate 1 side.

Underlayer

It is possible to use a metal having Ta or a (111) plane oriented face-centered cubic structure (fcc structure), or an alloy (for example, Ni, Ni—Nb, Ni—Ta, Ni—V, Ni—W, Pt and the like), as a material of the underlayer 4. In addition, even when the soft magnetic layer 2 takes a microcrystalline or amorphous structure, since there may be a case where the surface roughness (Ra) of the orientation control layer 3 is made large depending on materials or film formation conditions, it is possible to improve crystalline orientation of the perpendicular magnetic recording layer 6 by forming a nonmagnetic amorphous layer between the soft magnetic layer 2 and the orientation control layer 3 to thereby lower the surface roughness (Ra) of the orientation control layer 3.

Intermediate Layer

The intermediate layer 5 is provided over the underlayer 4. It is possible to employ Ru or Re used in a hexagonal closest packing structure (hop structure) similar to the perpendicular magnetic recording layer 6, or an alloy thereof, or an oxide thereof, as a material of the intermediate layer 5. In addition, since the intermediate layer 5 acts as a function of controlling orientation of the perpendicular magnetic recording layer 6, it is not limited to the materials used in the hexagonal closest packing structure (hcp structure), and can employ materials capable of, if possible, controlling orientation of the perpendicular magnetic recording layer 6.

Magnetic Recording Layer

The perpendicular magnetic recording layer 6 has a granular magnetic layer including at least an oxide. In addition, the perpendicular magnetic recording layer 6 is a layer in which recording of a signal is actually performed, and an axis of easy magnetization (crystalline c axis) thereof is chiefly vertically oriented with respect to the nonmagnetic substrate 1. Therefore, finally, a crystalline structure and a magnetic property of the perpendicular magnetic recording layer 6 determine recording and reproduction.

As constituent materials of the perpendicular magnetic recording layer 6, exemplified are Co-based alloy thin films of CoCr, CoCrPt, CoCrPtB, CoCrPtB—X, CoCrPtB—X—Y, CoCrPt—O, CoCrPt—SiO₂, CoCrPt—Cr₂O₃, CoCrPt—TiO₂, CoCrPt—ZrO₂, CoCrPt—Nb₂O₅, CoCrPt—Ta₂O₅, CoCrPtTiO₂ and the like. Meanwhile, X among the above-mentioned constituent materials denotes Ru, W and the like, and Y denotes Cu, Mg and the like.

In particular, when used is the magnetic layer (oxide magnetic layer) including the oxides of SiO₂, Cr₂O₃, TiO₂, ZrO₂, Nb₂O₅, Ta₂O₅ and the like and the Co alloys of CoCrPt and the like as constituent materials of the perpendicular magnetic recording layer 6, it is preferable that the nonmagnetic oxide adopts a granular structure by surrounding the periphery of ferromagnetic Co crystal particles. Hereby, magnetic interaction of the Co crystal particles is weakened, to thereby allow noise to be diminished. In embodiments, it is preferable that the perpendicular magnetic recording layer 6 is configured to form a granular magnetic layer in which at least one layer includes an oxide.

Protective Layer

The protective layer 7 is provided in order to protect the perpendicular magnetic recording medium 10 from damage due to contact of the magnetic head with the perpendicular magnetic recording medium 10. A carbon film, a SiO₂ film and the like axe preferably used as materials of the protective layer 7, and particularly the carbon film is more preferably used.

Lubricant Layer

It is preferable to use materials known in the past, for example, perfluoropolyether, fluorinated alcohol, fluorinated carboxylic acid and the like in the lubricant layer 8.

Next, the first, second and third embodiments of the manufacturing method of the perpendicular magnetic recording medium 10 shown in FIG. 1 will be described.

The manufacturing method of the perpendicular magnetic recording medium 10 shown in FIG. 1 is schematically composed of a cleaning process of the substrate, a process of forming the magnetic layer, an irradiation process with inert gas ions, a process of forming the protective layer, and a process of forming the lubricant layer. In the first, second and third embodiments, the cleaning process of the substrate, the process of forming the magnetic layer, and the process of forming the protective layer are common. The irradiation process with inert gas ions of the first embodiment is characterized by forming the soft magnetic layer 2, and then irradiating a surface of the soft magnetic layer with inert gas ions. The irradiation process with inert gas ions of the second embodiment is characterized by forming the intermediate layer 5, and then irradiating a surface of the intermediate layer with inert gas ions. The irradiation process with inert gas ions of the third embodiment is characterized by forming the granular magnetic layer constituting the perpendicular magnetic recording layer 6, and then irradiating a surface of the granular magnetic layer with inert gas ions.

Hereinafter, each of the processes will be described.

Cleaning Process of the Substrate

In the manufacturing process of a magnetic disk, first, cleaning and drying of the substrate is typically performed. Even in the embodiment, it is preferable to perform cleaning and drying prior to the formation thereof from a viewpoint of securing adhesion of each layer. In the cleaning process of the substrate, the cleaning method of the nonmagnetic substrate 1 is not limited to water cleaning, and also includes cleaning by etching (reverse sputtering). In addition, the substrate size is also not particularly limited.

Forming Process of the Magnetic Layer

In the forming process of the magnetic layer, the magnetic layer composed of the soft magnetic layer 2, the underlayer 4, the intermediate layer 5, and the perpendicular magnetic recording layer 6 is sequentially stacked formed on a data recording region of the nonmagnetic substrate 1.

A DC magnetron sputtering method or a RF sputtering method is typically used to form each layer of the soft magnetic layer 2, the underlayer 4, the intermediate layer 5, and the perpendicular magnetic recording layer 6. In addition, it is also possible to use an RF bias, a DC bias, a pulse DC, a pulse DC bias, an O₂ gas, a H₂O gas, a H₂ gas, and an N₂ gas.

The sputtering gas pressure at the time of film formation is appropriately determined in order to become optimal characteristics for each layer. Generally, the pressure is controlled to be in a range of a degree of 0.1 to 30 (Pa), and is adjusted while observing the performance of the perpendicular magnetic recording medium 10.

Meanwhile, it is preferable to form an asperity on the surface of the intermediate layer 5 by heightening a film formation gas pressure of the intermediate layer 5 in order to form the perpendicular magnetic recording layer 6 with a granular structure. Hereby, since an oxide of the magnetic layer including an oxide constituting the perpendicular magnetic recording layer 6 is collected in a concave portion of the surface of the intermediate layer 5, the perpendicular magnetic recording layer 6 becomes a granular structure. On the other hand, when the film formation gas pressure of the intermediate layer 5 is heightened, there may be a concern that the crystalline orientation of the intermediate layer 5 is deteriorated and the surface roughness is excessively large. For this reason, it is preferable to sequentially form the intermediate layer 5 as a two-layer structure of a low gas pressure film-forming layer and a high gas pressure film-forming layer. Hereby, it is possible to satisfy both maintenance of the orientation of the intermediate layer 5 and formation of a surface asperity.

Irradiation Process with Inert Gas Ions of the First Embodiment

The first embodiment is characterized by forming the soft magnetic layer 2, and then irradiating this soft magnetic layer 2 with inert gas ions. Since the soft magnetic layer 2 is easy to be oxidized because of plentiful inclusion of Co or Fe and the like, it is considered as a cause of corrosion of the perpendicular magnetic recording medium 10. Consequently, through the irradiation with inert gas ions, since inert elements are invaded into the soft magnetic layer 2 to thereby cause movement of the magnetic particles to be suppressed, it is considered that migration and the like of the magnetic particles of the Co crystal particles and the like (hereinafter, referred to as magnetic particles) is suppressed. In addition, it is considered that an active surface of the soft magnetic layer 2 is removed to thereby cause migration and the like of the magnetic particles to be controlled. Hereby, it is considered that the soft magnetic layer 2 is stabilized, and generation of migration and the like of the magnetic particles is suppressed even in hot and humid circumstances. Further, it is considered that the oxide of the surface of the soft magnetic layer 2 is removed, thereby causing the crystalline orientation of the layer formed on the soft magnetic layer 2 to be improved.

It is preferable to use gases of any one kind or more than one kinds selected from a group consisting of Ar, He, Xe and Kr in the inert gases. The above-mentioned elements axe preferable because the elements are chemically stable, and an effect of suppressing migration and the like of the magnetic particles is high.

It is preferable to use any method selected from a group consisting of an ion gun, inductively coupled plasma (ICP), and reactive ion plasma (RIB) in an irradiation method with inert gas ions. It is preferable to use ICP or RIE from a point of the large amount of irradiation.

The inductively coupled plasma (ICP) is a high-temperature plasma which is changed to a plasma state by applying a high voltage to gas, and is obtained by generating Joule heat caused due to an eddy current in the inside of the plasma by a variable magnetic field of high frequency. Since the inductively coupled plasma has a high electron density, it is possible to modify the magnetic characteristics with a high efficiency with respect to a large-area magnetic film.

The reactive ion plasma (RIE) is a plasma having high reactivity which reactive gases such as SF₆, CHF₃, CF₄ and CCl₄ are added to plasma. For this reason, it is possible to realize modification of the magnetic characteristics of the magnetic film with a higher efficiency.

Irradiation Process with Inert Gas Ions of the Second Embodiment

The second embodiment is characterized by forming the intermediate layer 5, and then irradiating this intermediate layer 5 with inert gas ions.

When Ru or Re, or the alloy thereof (hereinafter, referred to as Ru and the like) is used as the intermediate layer 5, since an oxidation layer and impurities in minute amounts of the surface of the intermediate layer 5 axe removed by irradiation with inert gas ions, it is considered that crystallization (fineness of a particle diameter and vertical orientation) of the perpendicular magnetic recording layer 6 stacked and formed on the intermediate layer 5 is improved, and SNR is improved.

On the other hand, when an oxide of Ru and the like is used as the intermediate layer 5, since the inert elements are invaded into the surface of the oxide magnetic layer by irradiating the magnetic layer including an oxide with inert gas ions, to thereby cause movement of the magnetic particles to be suppressed, or since an active surface of the magnetic layer including an oxide is removed, to thereby suppress migration and the like of the magnetic particles, it is considered that the intermediate layer 5 is stabilized, and generation of migration and the like of the magnetic particles is suppressed even in hot and humid circumstances.

It is preferable to use one or more inert gases selected from a group consisting of Ar, He, Xe and Kr. The above-mentioned elements are preferable because they are chemically stable, and an effect of suppressing migration and the like of the magnetic particles is high.

It is preferable to use any method selected from a group consisting of an ion gun, inductively coupled plasma (ICP), and reactive ion plasma (RIE) in an irradiation method with inert gas ions. It is preferable to use ICP or RIE from the point of a large amount of irradiation.

The inductively coupled plasma (ICP) is a high-temperature plasma which is changed to a plasma state by applying a high voltage to gas, and is obtained by generating Joule heat caused due to an eddy current in the inside of the plasma by a variable magnetic field of a high frequency. Since the inductively coupled plasma has a high electron density, it is possible to modify the magnetic characteristics with a high efficiency with respect to a large-area magnetic film.

The reactive ion plasma (RIB) is a plasma having high reactivity to which reactive gases such as SF₆, CHF₃, CF₄ and CCl₄ are added. For this reason, it is possible to realize modification of the magnetic characteristics of the magnetic film with a higher efficiency.

Irradiation Process with Inert Gas Ions of the Third Embodiment

The third embodiment is characterized by forming the perpendicular magnetic recording layer 6, and then irradiating the granular magnetic layer (oxide magnetic layer) including an oxide constituting the perpendicular magnetic recording layer 6 with inert gas ions. Since the inert elements are invaded into the surface of the oxide magnetic layer by irradiation with inert gas ions, thereby causing movement of the Co crystal particles composed of a Co alloy (hereinafter, referred to as Co crystal particles), it is considered that migration and the like of the Co crystal particles are suppressed. In addition, it is considered that the active surface of the oxide magnetic layer is removed, to thereby cause migration and the like of the Co crystal particles to be suppressed. Hereby, it is considered that the perpendicular magnetic recording layer 6 is stabilized, and generation of migration of the Co crystal particles is suppressed even in hot and humid circumstances.

It is preferable to use one or more inert gases selected from the group consisting of Ar, He and Xe. The above-mentioned elements are preferable because the elements are chemically stable, and an effect of suppressing migration and the like of the Co crystal particles is high.

It is preferable to use any method selected from the group consisting of an ion gun, inductively coupled plasma (ICP), and reactive ion plasma (RIE) in an irradiation method with inert gas ions. It is preferable to use ICP or RIE from a point of a large amount of irradiation.

The inductively coupled plasma (ICP) is a high-temperature plasma which is changed to a plasma state by applying a high voltage to gas, and is obtained by generating Joule heat caused due to an eddy current in the inside of the plasma by a variable magnetic field of a high frequency. Since the inductively coupled plasma has a high electron density, it is possible to modify the magnetic characteristics with a high efficiency with respect to a large-area magnetic film.

The reactive ion plasma (RIE) is a plasma having high reactivity to which reactive gases such as SF₆, CHF₃, CF₄ and CCl₄ are added. For this reason, it is possible to realize modification of the magnetic characteristics of the magnetic film with a higher efficiency.

Forming Process of the Protective Layer

In the formation of the protective layer 7, it is possible to use a sputtering method, a plasma CVD method, or the like, and the plasma CVD method is particularly preferable. Further, it is possible to use a magnetron plasma CVD method. In addition, the film thickness of the protective layer 7 is in the range of 1 to 10 (nm), preferably in the range of 2 to 6 (nm), and more preferably in the range of 2 to 4 (nm).

Forming Process of the Lubricant Layer

In the formation of the lubricant layer 8, methods known in the past such as, for example, a dipping method, a spin coating method, and the like can be used. In addition, the film thickness of the lubricant layer 8 is typically in the range of Ito 4 (nm).

As described above, it is possible to manufacture the perpendicular magnetic recording medium 10 shown in FIG. 1.

Magnetic Recording and Reproducing Apparatus

Next, a magnetic recording and reproducing apparatus of the perpendicular magnetic recording medium 10 mentioned above will be described.

FIG. 2 is a diagram showing an example of a magnetic recording and reproducing apparatus using the above-mentioned perpendicular magnetic recording medium 10. As shown in FIG. 2, the magnetic recording and reproducing apparatus 100 includes the perpendicular magnetic recording medium 10 having the above-mentioned constituents, a medium driving portion 101 that rotationally drives the perpendicular magnetic recording medium 10, a magnetic head 102 that records and reproduces information in the perpendicular magnetic recording medium 10, a head driving portion 103 that relatively moves the magnetic head 102 with respect to the perpendicular magnetic recording medium 10, and a recording and reproducing signal processing system 104.

The recording and reproducing signal processing system 104 processes data input from the outside to send a recording signal to the magnetic head 102, and processes a reproducing signal from the magnetic head 102 to thereby allow data to be sent to the outside.

It is possible to employ a magnetic head applied with a higher recording density which has a GMR element using the giant magneto resistance effect (GMR) and a TuMR element using the tunnel effect as well as an MR (Magneto Resistance) element using the anisotropic magneto resistance effect (AMR) as a reproducing element, in the magnetic head 102 used in the magnetic recording and reproducing apparatus 100 of the embodiment.

As described above, according to the manufacturing method of the perpendicular magnetic recording medium 10 of the first embodiment, since the soft magnetic layer 2 is irradiated with inert gas ions, it is possible to reduce corrosion of this soft magnetic layer 2. Hereby, it is possible to improve corrosion resistance of the perpendicular magnetic recording medium 10.

In addition, since the oxidation layer or the impurities and the like in minute amounts of the surface of the soft magnetic layer 2 are removed by irradiating the soft magnetic layer 2 with inert gas ions, it is possible to improve crystallization of the underlayer 4, the intermediate layer 5, and the perpendicular magnetic recording layer 6 which are stacked and formed on the soft magnetic layer 2.

Therefore, according to the manufacturing method of the perpendicular magnetic recording medium 10 of the first embodiment, it is possible to manufacture the perpendicular magnetic recording medium 10 which has excellent corrosion resistance and excellent in the magnetic recording characteristics. In addition, it is possible to provide the magnetic recording and reproducing apparatus 100 to which the perpendicular magnetic recording medium 10 manufactured by the manufacturing method of the first embodiment is applied.

As described above, according to the manufacturing method of the perpendicular magnetic recording medium 10 of the second embodiment, since the oxidation layer and the impurities in minute amounts of the surface of the intermediate layer 5 are removed by irradiation with inert gas ions in the case of using Ru or Re, or the alloy thereof (hereinafter, referred to as Ru and the like) as the intermediate layer 5, it is possible to improve crystallization (fineness of a particle diameter and vertical orientation) of the perpendicular magnetic recording layer 6 which is stacked and formed on the intermediate layer 5, and to better the SNR.

In addition, when an oxide such as Ru and the like is used as the intermediate layer 5, since movement of the magnetic particles is suppressed due to invasion of the inert elements into the surface of the oxide magnetic layer by irradiating the intermediate layer 5 with inert gas ions, or since migration and the like of the magnetic particles is suppressed by removing the active surface of the magnetic layer including an oxide, it is possible to stabilize the intermediate layer 5. For this reason, it is possible to suppress generation of migration and the like of the magnetic particles even in hot and humid circumstances.

Therefore, according to the manufacturing method of the perpendicular magnetic recording medium 10 of the second embodiment, the average particle diameter of the crystal particles constituting the perpendicular magnetic recording layer 6 is extremely fine, and a crystal c axis of the crystalline structure of the perpendicular magnetic recording layer 6, particularly the hexagonal closest packing structure (hcp structure) is oriented in a state of extremely small angular variance with respect to the substrate surface, to thereby allow the perpendicular magnetic recording medium 10 which has excellent corrosion resistance and excellent high recording density characteristics to be manufactured. In addition, it is possible to provide the magnetic recording and reproducing apparatus 100 to which the perpendicular magnetic recording medium 10 manufactured by the manufacturing method of the second embodiment is applied.

As described above, according to the manufacturing method of the perpendicular magnetic recording medium 10 of the third embodiment, since movement of the Co crystal particles composed of the Co alloy (hereinafter, referred to as Co crystal particles) is suppressed due to invasion of the inert elements into the surface of the oxide magnetic layer by irradiating the granular magnetic layer (oxide magnetic layer) including an oxide constituting the perpendicular magnetic recording layer 6 with inert gas ions, it is considered that migration of the Co crystal particles is suppressed. In addition, since it is considered that migration and the like of the Co crystal particles is suppressed by removing the active surface of the oxide magnetic layer, it is considered that the perpendicular magnetic recording layer 6 is stabilized, and that generation of migration and the like of the Co crystal particles is suppressed even in hot and humid circumstances.

Therefore, according to the manufacturing method of the perpendicular magnetic recording medium 10 of the third embodiment, it is possible to manufacture the perpendicular magnetic recording medium 10 which has excellent corrosion resistance of the perpendicular magnetic recording layer 6 and excellent high recording density characteristics. In addition, it is possible to provide the magnetic recording and reproducing apparatus 100 to which the perpendicular magnetic recording medium 10 manufactured by the manufacturing method of the third embodiment is applied.

In addition, the perpendicular magnetic recording medium 10 of the embodiment can be applied to a new perpendicular recording medium such as an ECC medium with high future improvement in the recording density anticipated, a disk read and write medium, and a pattern medium.

### EXAMPLES

Hereinafter, an advantage of the invention is made more obvious by examples. Meanwhile, the invention is not limited to the following examples, but can be appropriately modified and carried out within the scope without changing the gist thereof.

### Examples 1 to 6

A vacuum chamber for setting an HD glass substrate was previously evacuated at equal to or less than 1.0×10⁻⁵ (Pa).

Next, Co₂₈Fe₄Zr was formed to be a film thickness of 50 (nm) as a soft magnetic layer by using the sputtering method on this substrate.

Next, irradiation with inert gas ions was performed by irradiating the surface of the soft magnetic layer with plasma of the inert gases by using Ar, He, Xe and Kr. Irradiation with the plasma of the inert gases used the irradiation conditions of a quantity of flow of the gases of 5 (sccm), a pressure of 0.014 (Pa), an accelerating voltage of 300 (V), a current density of 0.4 (mA/cm²), a processing time of 5, 15, 25 (sec). Here, the perpendicular magnetic recording mediums processed at a processing time of Ar plasma: 5, 15, and 25 (sec) were set to examples 1, 2 and 3, respectively. In addition, the processing time was set to 15 (sec), and the perpendicular magnetic recording mediums processed using He, Xe and Kr as the plasma of the inert gases were set to examples 4, 5 and 6, respectively.

After irradiation with the plasma of the inert gases, NiFe that has a face-centered cubic structure (fcc structure) as an underlayer formed in the Ar atmosphere of a gas pressure of 0.6 (Pa) in order to be a film thickness of 5 (nm).

Next, as an intermediate layer, Ru was formed to 10 (nm) thickness in the Ar atmosphere of a gas pressure of 0.6 (Pa), and then was further formed 10 (nm) thickness by raising the gas pressure to 10 (Pa).

The perpendicular magnetic recording layer was formed in order of a main recording layer-an auxiliary recording layer in an Ar atmosphere at a pressure of 2 (Pa). The perpendicular magnetic recording layer was formed so that 90 (CoCr₁₂Pt₁₈)-10 (SiO₂) was set to a film thickness of 10 (nm) as the main recording layer. 90-10 in the above-mentioned 90 (CoCr₁₂Pt₁₈)-10 (SiO₂) denotes a mole ratio. Further, the above-mentioned 12 and 18 denote that Cr is 12 mole %, Pt is 18 mole %, and Co is a remnant, respectively.

Next, a carbon film (C film) was formed as a protective layer, and perfluoropolyether (PFPE) was further applied as a lubricant layer to a thickness of 15 (Å) by the dipping method.

### Comparative Example 1

The magnetic recording medium was manufactured using the manufacturing conditions similar to those of examples 1 to 6. Here, the perpendicular magnetic recording medium in which the soft magnetic layer was not irradiated with the plasma of the inert gases was set to comparative example 1.

Evaluation of Electromagnetic Conversion Characteristics

Evaluation of the electromagnetic conversion characteristics was performed using a spin stand with respect to each of the magnetic recording mediums manufactured as the examples and the comparative example. In particular, an SNR value when a signal of 750 kFCI was recorded was measured in an evaluation magnetic head by using the vertical recording head for recording, and using the TuMR head for reproduction. A measured result thereof is shown in Table 1.

Evaluation of the Crystalline Structure

Evaluation of the crystalline structure was performed using a half value of a rocking curve with respect to each of the magnetic recording mediums manufactured as the examples and the comparative example. In particular, first, a film formed on the substrate was applied to an X-ray diffractometer, and then a crystal plane parallel to the substrate surface was analyzed.

Here, when a sample includes a film having a hexagonal close-packed structure like the intermediate layer or the magnetic recording layer, a diffraction peak corresponding to the crystal plane thereof is observed. In the case of the perpendicular magnetic recording medium using the Co-based alloy, since a direction do axis [002] of the hexagonal close-packed structure is oriented so as to be perpendicular to the substrate surface, a peak corresponding to a (002) plane is observed.

Next, when an optical system is swung with respect to the substrate surface with the Bragg angle by which the (002) plane is diffracted being maintained, a diffraction intensity of the (002) crystal plane was plotted with respect to an angle by which the optical system was tilted, and one diffraction peak (called a rocking curve) was drawn.

Here, when the (002) crystal plane is arranged extremely well parallel to the substrate surface, a rocking curve in an acute shape is obtained. On the other hand, when the direction of the (002) crystal plane is widely scattered, a broad rocking curve is obtained.

Therefore, it is possible to use a half-value width Δθ50 of this rocking curve as a good or bad index of the crystalline orientation of the perpendicular magnetic recording medium. As this value of Δθ50 is smaller, the crystalline orientation of the perpendicular magnetic recording medium can be evaluated to be more excellent. The measured result of Δθ50 is shown in Table 1.

TABLE 1

| | | | Electromagnetic | |
|---|---|---|---|---|
| | Irradiation | Irradiation | Conversion | Δθ50 |
| | Element | Time (sec) | Characteristics (SNR; dB) | (°) |
| Example 1 | Ar | 5 | 12.9 | 3.5 |
| Example 2 | Ar | 15 | 12.8 | 3.3 |
| Example 3 | Ar | 25 | 12.9 | 3.3 |
| Example 4 | He | 15 | 12.7 | 3.6 |
| Example 5 | Xe | 15 | 13.1 | 3.2 |
| Example 6 | Kr | 15 | 12.7 | 3.5 |
| Example 7 | Ar | 5 | 13.1 | 3.2 |
| Example 8 | Ar | 15 | 13.3 | 3.1 |
| Example 9 | Ar | 25 | 13.4 | 2.9 |
| Example 10 | He | 15 | 13.2 | 2.8 |
| Example 11 | Xe | 15 | 13.6 | 3.4 |
| Example 12 | Kr | 15 | 13.3 | 3.2 |
| Comparative | — | 0 | 12.4 | 4.4 |
| Example 1 | | | | |
| Comparative | — | 0 | 12.7 | 4.2 |
| Example 2 | | | | |

As shown in Table 1, it was be confirmed that the electromagnetic conversion characteristics (SNR) were improved in the examples 1, 2 and 3 where irradiation with the Ar plasma was performed and in the examples 4, 5 and 6 where irradiation with the plasma of He, Xe and Kr was performed, with respect to the comparative example 1 where the soft magnetic layer was not irradiated with the plasma of the inert gases.

In addition, it could be confirmed that the crystalline structure (crystalline orientation) was considerably improved in the examples 1 to 6 with respect to the comparative example 1.

### Examples 7 to 12

A vacuum chamber for setting an HD glass substrate was previously evacuated at equal to or less than 1.0×10⁻⁵ (Pa).

Next, Co₂₈Fe₄Zr was formed as a soft magnetic layer with thickness of 50 nm by using a sputtering method on this substrate.

Next, NiFe that has a face-centered cubic structure (fcc structure) as an underlayer formed in the Ar atmosphere of a gas pressure of 0.6 (Pa) in order to obtain a film thickness of 5 (nm).

Next, Ru was formed as an intermediate layer in the Ar atmosphere of a gas pressure of 0.6 (Pa) at a thickness of 10 (nm), and then was further formed 10 (nm) thickness by raising the gas pressure to 10 (Pa).

After formation of the intermediate layer, the surface of the intermediate layer was irradiated with plasma of the inert gases. Ar, He, Xe and Kr were used as the inert gases. In addition, irradiation with plasma of the inert gases used the irradiation conditions of the quantity of flow of the gases of 5 (sccm), a pressure of 0.014 (Pa), an accelerating voltage of 300 (V), a current density of 0.4 (mA/cm²), a processing time of 5, 15, 25 (sec).

Here, the perpendicular magnetic recording mediums processed at a processing time of Ar plasma of 5, 15, and 25 (sec) were set to examples 7, 8 and 9, respectively. In addition, the processing time was set to 15 (sec), and the perpendicular magnetic recording mediums which were plasma-processed using He, Xe and Kr as the plasma of the inert gases were set to examples 10, 11 and 12, respectively.

After irradiation with the plasma of the inert gases, the perpendicular magnetic recording layer was formed in the order of a main recording layer-an auxiliary recording layer in the Ar atmosphere of a gas pressure of 2 (Pa). The perpendicular magnetic recording layer was formed so that 90 (CoCr₁₂Pt₁₈)-10 (SiO₂) was set to a film thickness of 10 (nm) as the main recording layer. 90-10 in the above-mentioned 90 (CoCr₁₂Pt₁₈)-10 (SiO₂) denotes a mole ratio. Further, the above-mentioned 12 and 18 denote that Cr is 12 mole %, Pt is 18 mole %, and Co is a remnant, respectively.

Next, a carbon film (C film) was formed as a protective layer, and perfluoropolyether (PEPE) was further applied as a lubricant layer to a thickness of 15 (Å) by the dipping method.

### Comparative Example 1

The magnetic recording medium was manufactured using manufacturing conditions similar to those of examples 7 to 12. Here, the perpendicular magnetic recording medium in which the intermediate layer was not irradiated with the plasma of the inert gases was set to comparative example 2.

Evaluation of Electromagnetic Conversion Characteristics

Evaluation of the electromagnetic conversion characteristics was performed using a spin stand with respect to each of the magnetic recording mediums manufactured as the examples and the comparative example. In particular, an SNR value when a signal of 750 kFCI was recorded was measured in an evaluation magnetic head by using the vertical recording head for recording, and using the TuMR head for reproduction. A measured result thereof is shown in Table 1.

Evaluation of the Crystalline Structure

Evaluation of the crystalline structure was performed using a half value of a rocking curve with respect to each of the magnetic recording mediums manufactured as the examples and the comparative example. In particular, first, a film formed on the substrate was applied to an X-ray diffractometer, and then a crystal plane parallel to the substrate surface was analyzed.

Here, when a sample includes a film having a hexagonal close-packed structure like the intermediate layer or the magnetic recording layer, a diffraction peak corresponding to the crystal plane thereof is observed. In the case of the perpendicular magnetic recording medium using the Co-based alloy, since a direction of c axis [002] of the hexagonal close-packed structure is oriented so as to be perpendicular to the substrate surface, a peak corresponding to a (002) plane is observed.

Next, when an optical system is swung with respect to the substrate surface with the Bragg angle by which the (002) plane is diffracted being maintained, diffraction intensity of the (002) crystal plane was plotted with respect to an angle by which the optical system was tilted, and one diffraction peak (called a rocking curve) was drawn.

Here, when the (002) crystal plane is arranged extremely well parallel to the substrate surface, a rocking curve in an acute shape is obtained. On the other hand, when the direction of the (002) crystal plane is widely scattered, a broad rocking curve is obtained.

Therefore, it is possible to use a half-value width Δθ50 of this rocking curve as a good or bad index of the crystalline orientation of the perpendicular magnetic recording medium. As this value of Δθ50 is smaller, the crystalline orientation of the perpendicular magnetic recording medium can be evaluated to be more excellent. The measured result of Δθ50 is shown in Table 1.

As shown in Table 1, it could be confirmed that the electromagnetic conversion characteristics (SNR) were improved in the examples 7, 8 and 9 where irradiation with the Ar plasma was performed and in the examples 10, 11 and 12 where irradiation with the plasma of He, Xe and Kr was performed, with respect to the comparative example 2 where the intermediate layer was not irradiated with plasma of the inert gases.

In addition, it was be confirmed that the crystalline structure (crystalline orientation) was considerably improved in the examples 7 to 12 with respect to the comparative example 2.

### Example 13 to 15

A vacuum chamber for setting an HD glass substrate was previously evacuated to be equal to or less than 1.0×10⁻⁵ (Pa).

Next, using a sputtering method, Co₂₈Fe₄Zr was formed with a film thickness of 50 (nm) as the soft magnetic layer, and NiFe with a face-centered cubic structure (fcc structure) as the underlayer was formed with a film thickness of 5 (nm), the substrate is formed with films in the Ar atmosphere of the gas pressure of 0.6 (Pa).

Next, as the intermediate layer, after Ru was formed with a film thickness of 10 (nm) in an Ar atmosphere of the gas pressure of 0.6 (Pa), the gas pressure was increased to be 10 (Pa) and Ru was further formed with a film thickness of 10 (nm).

The perpendicular magnetic recording layer was formed in an order of the main recording layer—the auxiliary recording layer in an Ar atmosphere of the gas pressure of 2 (Pa). As the main recording layer, 90(CoCr₁₂Pt₁₈)-10(SiO₂) was formed with a film thickness of 10 (nm). 90-10 in the above-mentioned 90(CoCr₁₂Pt₁₈)-10(SiO₂) represents the mole ratio. Further, the above-mentioned 12 and 18 denote that Cr is 12 mole %, Pt is 18 mole %, and Co is a remnant.

Next, the carbon film (C film) was formed as the protective layer, and then perfluoropolyether (PFPE) was coated with a thickness of 15 (Å) as a lubricant layer by the dipping method.

Next, irradiation with inert gas ions was performed on the surface of the magnetic layer with Ar plasma using Ar. In the irradiation with the Ar plasma, irradiation conditions in which the quantity of Ar gas flow of 5 (sccm), pressure of 0.014 (Pa), accelerating voltage of 300 (V), current density of 0.4 (mA/cm²), processing time of 5, 15, 25 (sec) were used. Here, examples 13 to 15 represent the perpendicular magnetic recording mediums which were processed during the processing time of Ar plasma of 5, 15, 25 (see).

### Comparative Example 3

Using the same manufacturing conditions as those of examples 13 to 15, a magnetic recording medium was manufactured. Here, the comparative example 3 represents the perpendicular magnetic recording medium in which the Ar plasma irradiation of the magnetic film was not performed.

Evaluation of Electromagnetic Conversion Characteristics

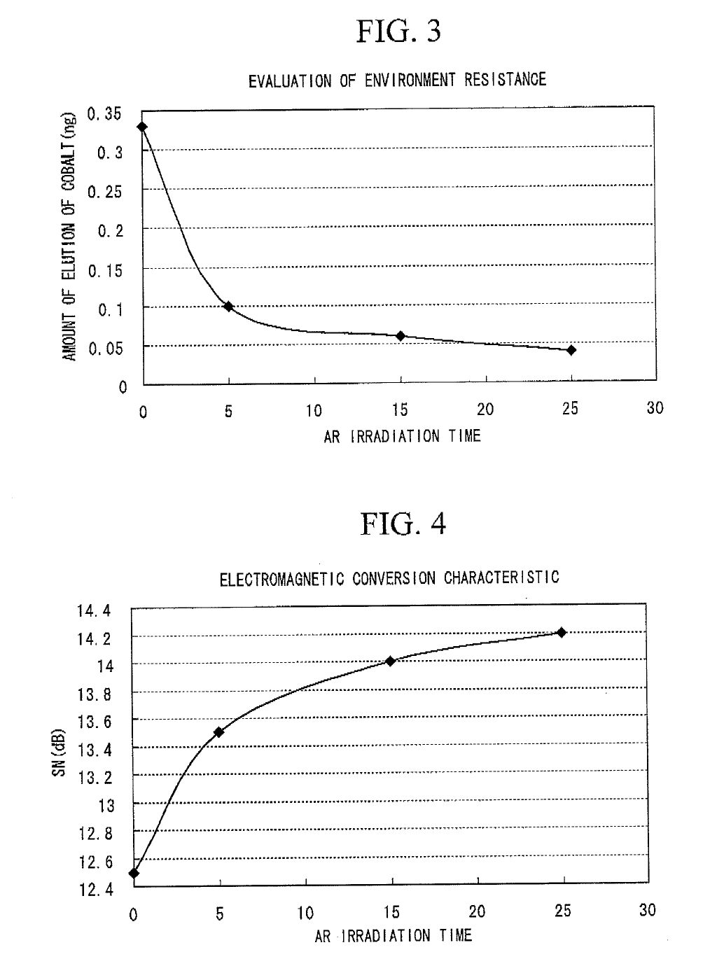

The evaluation of the electromagnetic conversion characteristics was performed using the spin stand on the magnetic recording mediums which were manufactured as examples 13 to 15 and comparative example 3. In particular, in the evaluation magnetic head, the vertical recording head for recording and the TuMR head for reproduction were used and an SNR value was measured when the signal of 750 kFCI is recorded. The measured result is shown in Table 2 and FIG. 3.

TABLE 2

| | Ar | Electromagnetic | |
|---|---|---|---|
| | Irradiation | Conversion | amount of |
| | Time (sec) | Characteristics (SNR; dB) | elution of cobalt |
| Example 13 | 5 | 13.5 | 0.10 |
| Example 14 | 15 | 14.0 | 0.06 |
| Example 15 | 25 | 14.2 | 0.04 |
| Comparative | 0 | 12.5 | 0.33 |
| Example 3 | | | |

As shown in Table 2 and FIG. 3, it can be confirmed that the electromagnetic conversion characteristics (SNR) in examples 13 to 15 in which the Ar irradiation was performed are significantly improved more than those of the comparative example 3 in which the Ar irradiation was not performed on the magnetic film.

Evaluation of Environment Resistance

The evaluation of the environment resistance was performed on the magnetic recording mediums which were manufactured as examples 13 to 15 and comparative example 3. In particular, the magnetic recording medium was subjected to a shelf test for 48 hours under conditions of a temperature of 80° C. and a humidity of 80%, and corrosion occurring on the surface of the magnetic recording medium was investigated.

In particular, 3% nitric acid aqueous solution dropped on the surface of each of the magnetic recording mediums at ten places by each 100 (μL), and the magnetic recording medium was covered with a Petri dish for one hour, and then the droplet was withdrawn using a pipette, and cobalt (Co) included in the droplet was quantitatively analyzed. The amount of Co included in the droplet totaled 1000 (μL) as shown in Table 2 and FIG. 4.

As shown in Table 2 and FIG. 4, the amount of elution of cobalt (Co) of examples 13 to 15 in which the Ar irradiation was performed was smaller than that of the comparative example 3 in which the Ar irradiation was not performed on the magnetic film. Therefore, it can be confirmed that the corrosion resistance is improved.

### Example 16

Irradiation with the plasma of the inert gas was performed on the soft magnetic layer in the condition of the example 5, irradiation with the plasma of the inert gases was performed on the intermediate layer in the condition of the example 11, irradiation with the plasma of the inert gases was performed was performed on the granular magnetic layer in the condition of the example 15, and the example 16 represented the perpendicular magnetic recording medium which was manufactured when other manufacturing conditions were equal to those of the example 5.

As in the examples of the magnetic recording medium manufactured in the example 16, the evaluation of the electromagnetic conversion characteristics, the evaluation of the environment resistance, and the evaluation of the crystalline structure were performed. The result is shown in the following.

Electromagnetic Conversion Characteristics (SNR; dB): 14.3

Amount of Cobalt (Co) Elution (ng): 0.02

Δθ50(°): 3.1

1. A method of manufacturing a perpendicular magnetic recording medium comprising a soft magnetic layer, an underlayer, an intermediate layer, and a perpendicular magnetic recording layer which has a granular magnetic layer containing at least an oxide, on a nonmagnetic substrate, the method at least comprising a process of forming a magnetic layer, an irradiation process with inert gas ions and a process of forming a protective layer,
wherein the irradiation process with inert gas ions comprises at least one of:
a process of irradiating a surface of the soft magnetic layer with inert gas ions, after forming the soft magnetic layer;
a process of irradiating a surface of the intermediate layer with inert gas ions, forming the intermediate layer; and
a process of irradiating a surface of the granular magnetic layer with inert gas ions, after forming the granular magnetic layer that constitutes the perpendicular magnetic recording layer.

2. The method of manufacturing the perpendicular magnetic recording medium according to claim 1, wherein the inert gases are one or more inert gases selected from the group consisting of Ar, He, Xe and Kr.

3. The method of manufacturing the perpendicular magnetic recording medium according to claim 1, wherein inert gas ions are irradiated by a method selected from the group consisting of an ion gun, inductively-coupled plasma (ICP), and reactive ion plasma (RIE).

4. A perpendicular magnetic recording medium manufactured by the manufacture method according to claim 1.

5. A magnetic recording and reproducing apparatus comprising a perpendicular magnetic recording medium, and a magnetic head that records and reproduces information in the perpendicular magnetic recording medium, wherein the perpendicular magnetic recording medium is a perpendicular magnetic recording medium manufactured by a manufacture method according to claim 1.
